(19) United States
(12) Patent Application Publication
(10) Pub. No.: US 2022/0030589 A1
(43) Pub. Date: Jan. 27, 2022

(54) PACKET RECEIVING SYSTEM AND PACKET RECEIVING METHOD

(71) Applicant: Realtek Semiconductor Corporation, Hsinchu (TW)

(72) Inventors: Zhao-Ming Li, Suzhou (CN); Yi-Dong He, Suzhou (CN); Zuo-Hui Peng, Suzhou (CN); Jian-Jun Zhou, Suzhou (CN); Guo-Feng Zhang, Suzhou (CN); Jie-Hong Yu, Suzhou (CN)

(21) Appl. No.: 17/116,041

(22) Filed: Dec. 9, 2020

(51) Int. Cl. H04W 72/04

(52) U.S. Cl. CPC H04W 72/0446; H04W 4/80

(57) ABSTRACT

A packet receiving system includes a transmitter device, a receiver device, and a communication device. The transmitter device is configured to transmit a plurality of packets periodically according to a packet gap. The receiver device performs a receiving operation for the packets in a plurality of first working time intervals. A sum of lengths of the first working time intervals corresponds to a length of the packet gap. The communication device performs a receiving operation or a transmitting operation in a plurality of second working time intervals. A length of each of the second working time intervals corresponds to the length of the packet gap. Each of the second working time intervals is arranged in between two of the first working time intervals.

### RELATED APPLICATIONS

This application claims priority to Chinese Application Serial Number 202010716275.0, filed Jul. 23, 2020, which is herein incorporated by reference.

### BACKGROUND

### Technical Field

The present disclosure relates to a packet receiving system and a packet receiving method. More particularly, the present disclosure relates to a packet receiving system and a packet receiving method with better operating efficiency.

### Description of Related Art

In generally, in a communication system, a transmitter device can transmit packets to a receiver device through specific communication technologies.

Due to some limitations, devices in the communication system cannot work simultaneously (e.g., devices cannot work simultaneously if they have to share specific hardware). If one of the devices receives packets for a long time, the others have to wait.

### SUMMARY

One embodiment of the present disclosure is related to a packet receiving system. The packet receiving system includes a transmitter device, a receiver device, and a communication device. The transmitter device is configured to transmit a plurality of packets periodically according to a packet gap. The receiver device performs a receiving operation for the packets in a plurality of first working time intervals. A sum of lengths of the first working time intervals corresponds to a length of the packet gap. The communication device performs a receiving operation or a transmitting operation in a plurality of second working time intervals. A length of each of the second working time intervals corresponds to the length of the packet gap. Each of the second working time intervals is arranged in between two of the first working time intervals.

One embodiment of the present disclosure is related to a packet receiving method. The packet receiving method includes the following operations: transmitting a plurality of packets periodically according to a packet gap by a transmitter device; performing a receiving operation for the packets in a plurality of first working time intervals by a receiver device, in which a sum of lengths of the first working time intervals corresponds to a length of the packet gap; and performing a receiving operation or a transmitting operation in a plurality of second working time intervals by a communication device, in which a length of each of the second working time intervals corresponds to the length of the packet gap, in which each of the second working time intervals is arranged in between two of the first working time intervals.

As shown in the above embodiments, in the packet receiving system and the packet receiving method of the present disclosure, the receiving device and the communication device can work by turns so that the waiting time of the communication device can be reduced. This ensures the receiving accuracy of the receiving device and prevents the communication device from being in a waiting status for a long time. Accordingly, the operation efficiency of the packet receiving system can be increased.

### BRIEF DESCRIPTION OF THE DRAWINGS

The disclosure can be more fully understood by reading the following detailed description of the embodiment, with reference made to the accompanying drawings as follows:

FIG. 1 is a schematic diagram illustrating a packet receiving system according to some embodiments of the present disclosure.

FIG. 2 is a schematic diagram illustrating working sequences according to some embodiments of the present disclosure.

FIG. 3 is a schematic diagram illustrating working sequences according to some embodiments of the present disclosure.

FIG. 4 is a schematic diagram of the working sequences in FIG. 3 illustrated in an alternative expression according to some embodiments of the present disclosure.

FIG. 5 is a flow diagram illustrating a packet receiving method according to some embodiments of the present disclosure.

FIG. 6 is a detailed flow diagram illustrating some operations of the packet receiving method in FIG. 5 according to some embodiments of the present disclosure.

### DETAILED DESCRIPTION

The embodiments in the following descriptions are described in detail with the accompanying drawings, but the examples provided are not intended to limit the scope of the disclosure covered by the present disclosure. The structure and operation are not intended to limit the execution order. Any structure regrouped by elements, which has an equal effect, is covered by the scope of the present disclosure. In addition, the drawings are merely for illustration and are not illustrated according original sizes. For ease of understanding, the same or similar components in the following descriptions will be described with the same symbols.

In the present disclosure, “connected” or “coupled” may be referred to “electrically connected” or “electrically coupled.” “Connected” or “coupled” may also be referred to operations or actions between two or more elements.

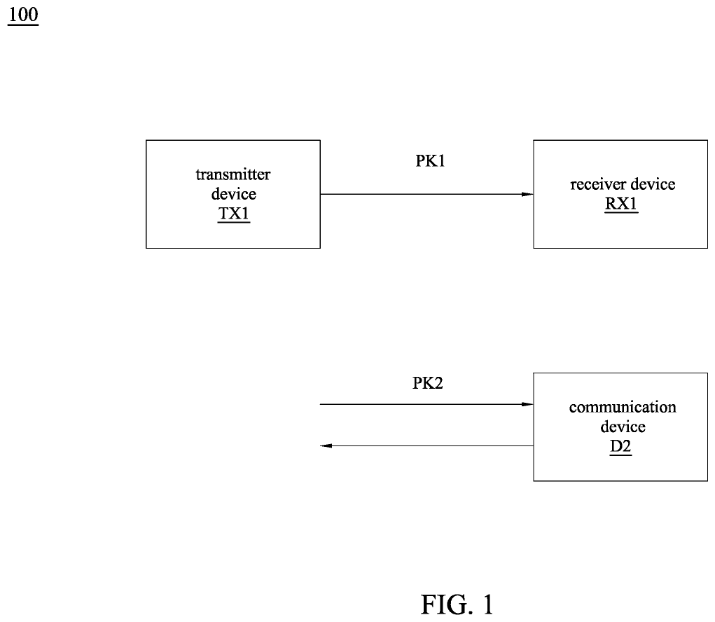

Reference is made to FIG. 1. FIG. 1 is a schematic diagram illustrating a packet receiving system 100 according to some embodiments of the present disclosure. As illustrated in FIG. 1, the packet receiving system 100 includes a transmitter device TX1, a receiver device RX1, and a communication device D2. The communication device D2 may be a transmitter device, a receiver device, or a transceiver device.

The transmitter device TX1 can transmit multiple packets PK1 to the receiver device RX1. The communication device D2 can transmit or receive multiple packets PK2. The packets PK1 and the packets PK2 may be in different formats. For example, the transmitter device TX1 may be an electronic device adopting Wi-Fi standard and is configured to transmit the packets PK1 with Wi-Fi standard. Correspondingly, the receiver device RX1 may be an electronic device adopting Wi-Fi standard and is configured to receive the packets PK1 with Wi-Fi standard. The communication device D2 may be an electronic device adopting Bluetooth standard and is configured to transmit or receive the packets PK2 with Bluetooth standard. However, the present disclosure is not limited to the devices described above and is not limited to the packet formats described above.

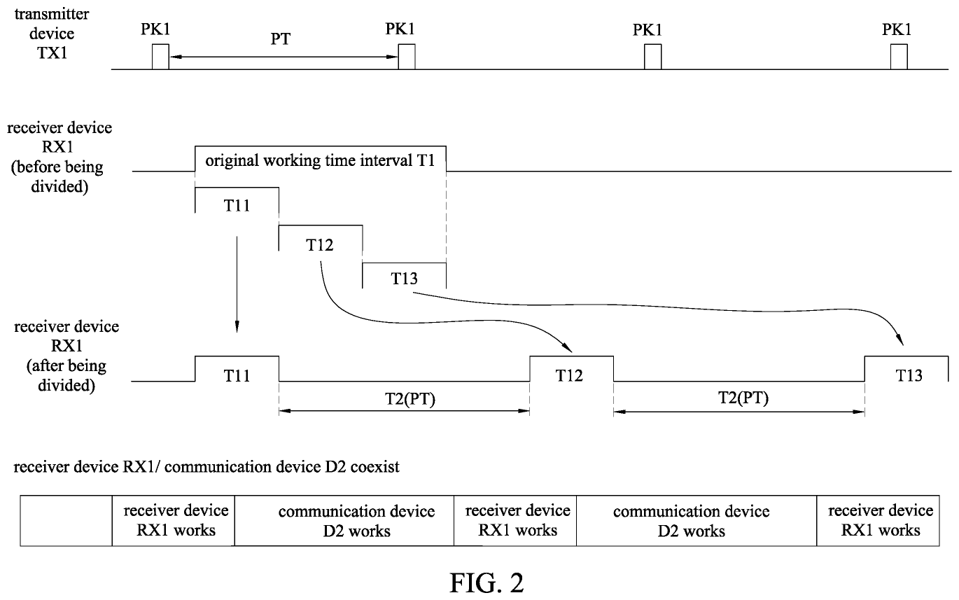

References are made to FIG. 1 and FIG. 2. FIG. 2 is a schematic diagram illustrating working sequences according to some embodiments of the present disclosure. As illustrated in FIG. 2, the transmitter device TX1 transmits the packets PK1 periodically with a packet gap PT. In some embodiments, a length of an original working time interval T1 of the receiver device RX1 can be set as the same as a length of the packet gap PT. In some other embodiments, the length of the original working time interval T1 of the receiver device RX1 can be set to an interval longer than the length of the packet gap PT, in order to ensure that the receiver device RX1 can successfully receive the packets PK1 (i.e., set the working time interval of the receiver device RX1 to be longer than the packet gap PT to increase the possibility of receiving at least one of the two adjacent packets PK1).

Then, the original working time interval T1 is divided into multiple first working time intervals T11-T13. In some embodiments, lengths of the first working time intervals T11-T13 are identical. In some other embodiments, the lengths of the first working time intervals T11-T13 are not identical (may be partially identical).

In the embodiments where the length of the original working time interval T1 is equal to the length of the packet gap PT, if the length of the packet gap PT is M seconds and the length of the original working time interval T1 is divided into N first working time intervals, a length of one of the N first working time intervals is equal to a ratio of M to N, in which N is a positive integer greater than 1. In the embodiments where the length of the original working time interval T1 is greater than the length of the packet gap PT, if the length of the packet gap PT is M seconds and the length of the original working time interval T1 is divided into N first working time intervals, a length of one of the N first working time intervals is greater than the ratio of M to N.

A second working time interval T2 is arranged between the first working time interval T11 and the first working time interval T12, and another second working time interval T2 is arranged between the first working time interval T12 and the first working time interval T13. In some embodiments, each of the lengths of the first working time intervals T11-T13 is less than a length of each of the second working time intervals T2.

In some application situations, the receiver device RX1 and the communication device D2 cannot operate simultaneously. For example, only one of the receiver device RX1 and the communication device D2 can operate if the receiver device RX1 and the communication device D2 share the same antenna (as the aforementioned embodiments, the Wi-Fi device and the Bluetooth device in a cell phone share the same antenna). Thus, in the example of FIG. 2, the receiver device RX1 performs the receiving operation in the first working time intervals T11-T13, in order to receive the packets PK1 from the transmitter device TX1. The communication device D2 performs the receiving operation or the transmitting operation in the second working time intervals T2 in order to receive or transmit the packets PK2. That is, the receiver device RX1 and the communication device D2 can operate by turns to utilize the same antenna. In some embodiments, the length of the each of the second working time intervals T2 of the communication device D2 can be set as the same as the length of the packet gap PT.

In some related approaches, the operation priority of the receiver device RX1 and the operation priority of the communication device D2 are decided based on a predetermined rule. If the operation priority of the receiver device RX1 is higher than the operation priority of the communication device D2, the receiver device RX1 performs the receiving operation for the packets PK1 from the transmitter device TX1 at first. In this case, if plenty of packets PK1 are sent in the air, the communication device D2 is unable to receive or transmit the packets PK2 for a long time. Similarly, in a case where the receiver device RX1 and the communication device D2 share the same radio frequency apparatus, the communication device D2 cannot request for receiving operation or transmitting operation when the receiver device RX1 occupies the radio frequency apparatus.

In some other related approaches, the original working time interval T1 of the receiver device RX1 is not divided into multiple working time intervals (e.g., the aforementioned first working time intervals). In other words, the receiver device RX1 can use the entire original working time interval T1 (e.g., the length of the original working time interval T1 shown in the second row of FIG. 2) to perform the receiving operation for the packets PK1 from the transmitter device TX1, and the communication device D2 can receive or transmit the packets PK2 (e.g., the unlabeled time interval after the original working time interval T1 shown in the second row of FIG. 2) afterwards. In these related approaches, the communication device D2 needs to wait for a long time (i.e., the original working time interval T1) until it can perform the receiving operation or the transmitting operation. However, if the length of the original working time interval T1 of the receiver device RX1 is set to be less than the length of the packet gap PT to prevent the communication device D2 from being in the waiting status for a long time, such configuration can cause the receiver device RX1 fail to receive the packets PK1 from the transmitter device TX1 (e.g., the receiver device RX1 can coincidentally misses both two adjacent packets PK1).

Compared to the aforementioned related approaches, in the packet receiving system 100 of the present disclosure, the entire original working time interval T1 (which is configured for receiving the periodic packets PK1) of the receiver device RX1 is divided into the first working time intervals T11-T13 with shorter lengths. This can shorten the waiting time of the communication device D2 so that the power consumption of the communication device D2 can be reduced. In addition, since the sum of the lengths of the first working time intervals T11-T13 is equal to (or greater than) the length of the packet gap PT, this ensures that the receiver device RX1 can receive at least one of the packets PK1 from the transmitter device TX1. In this way, the operations of the receiver device RX1 would be less likely to delay the operations of the communication device D2.

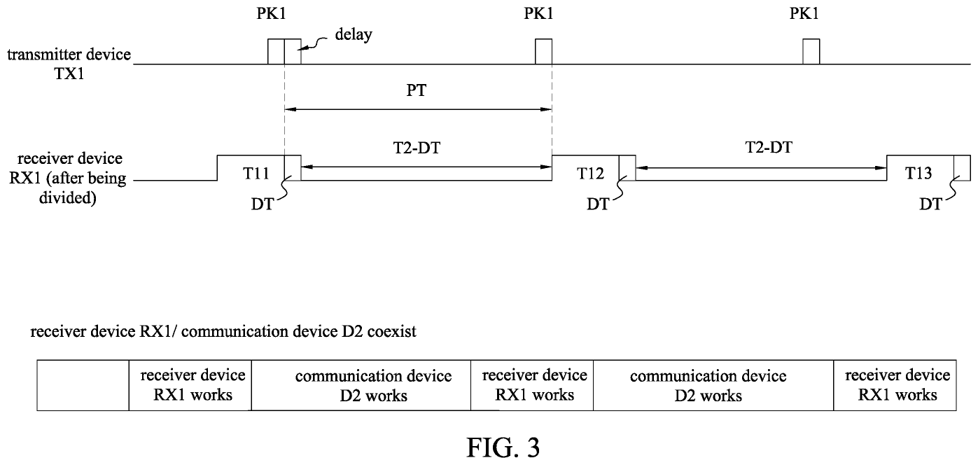

Reference is made to FIG. 3. FIG. 3 is a schematic diagram illustrating working sequences according to some embodiments of the present disclosure. As illustrated in FIG. 3, in some cases, the packets PK1 transmitted from the transmitter device TX1 are delayed. To avoid that the receiver device RX1 fails to receive the delayed packets PK1, the first segment of working time interval of the receiver device RX1 is arranged to be a longer interval, which is in length of a sum of the first working time interval T11 and a protection time interval DT. In the same manner, the second segment of working time interval of the receiver device RX1 is arranged to be the first working time interval T12 with an extension of the protection time interval DT and the third segment of working time interval of the receiver device RX1 is arranged to be the first working time interval T13 with an extension of the protection time interval DT (i.e., a buffer length is added into each of the working time intervals of the receiver device RX1).

Correspondingly, the lengths of the working time interval of the communication device D2 are arranged to be the length of the second working time interval T2 (the length of the packet gap PT) reduces the length of the protection time interval DT. In other words, each of the rearranged working time intervals of the communication device D2 is less than the packet gap PT. Compared with the example in FIG. 2, the lengths of the working time intervals of the receiver device RX1 in FIG. 3 are increased and the lengths of the working time intervals of the communication device D2 are decreased.

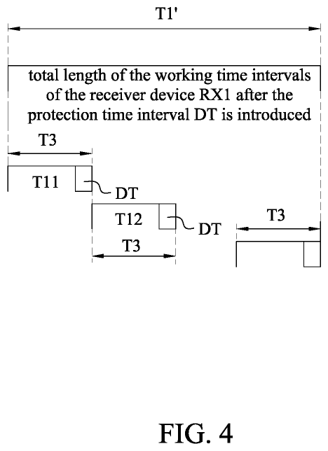

Reference is made to FIG. 4. FIG. 4 is a schematic diagram of the working sequences in FIG. 3 illustrated in an alternative expression according to some embodiments of the present disclosure. Similar to FIG. 3, a sum of the length of the first working time interval T11 and the length of the protection time interval DT is set to be a length of a third working time interval T3, a sum of the length of the first working time interval T12 and the length of the protection time interval DT is also set to be the length of the third working time interval T3, and such rule is applied to N first working time intervals. Accordingly, if the length of the each of the first working time intervals (e.g., the first working time intervals T11, T12) is t1, the formula (1) is shown as below:

T1′=N×(t1+DT)=N×T3 (1)

T1′ is a total length of the working time intervals of the receiver device RX1 after the protection time interval DT is introduced.

References are made to FIG. 3 and FIG. 4. If the packets PK1 and the receiver device RX1 are configured with Wi-Fi standard, the packets PK1 may be some beacon packets. The beacon packets are periodic packets, with packet gap PT of, for example, 102.4 milliseconds. If the length of the packet gap PT (102.4 milliseconds) is divided into 3 segments (N is 3), the first working time interval T11, the first working time interval T12, or the first working time interval T13 is in length of the ratio (34.1 milliseconds) of the length of the packet gap PT (102.4 milliseconds) to 3. If the length of the protection time interval DT is 2.4 milliseconds, the length of the third working time interval T3 (36.5 milliseconds) is equal to a sum of the length of the protection time interval DT (2.4 milliseconds) and the length of one of the first working time interval T11, the length of the first working time interval T12 and the length of the first working time interval T13 (34.1 milliseconds). In some cases, the length of the third working time interval T3 is rounded to its integer part and the rounded length of the third working time interval T3 is 37 milliseconds. Accordingly, the length of the second working time interval T2 (100 milliseconds) of the communication device D2 in FIG. 3 is a difference of the length of the packet gap PT (102.4 milliseconds) and the length of the protection time interval DT (2.4 milliseconds).

Based on the aforementioned formula (1), a total length of the working time intervals T1′ of the receiver device RX1 plus the length of the protection time interval DT is 106.2 milliseconds. Since 106.2 milliseconds is greater than 102.4 milliseconds, the total length of the working time intervals T1′ can cover at least one of the two adjacent packets PK1, so the rate that the receiver device RX1 successfully receives packets can be increased.

Based on the foregoing, after the receiver device RX1 performs the receiving operation for 37 milliseconds, the communication device D2 takes over to perform the receiving operation or the transmitting operation for 100 milliseconds. In this case, the percentage of working time of the communication device D2 is 73% (i.e., 100/(100+37)).

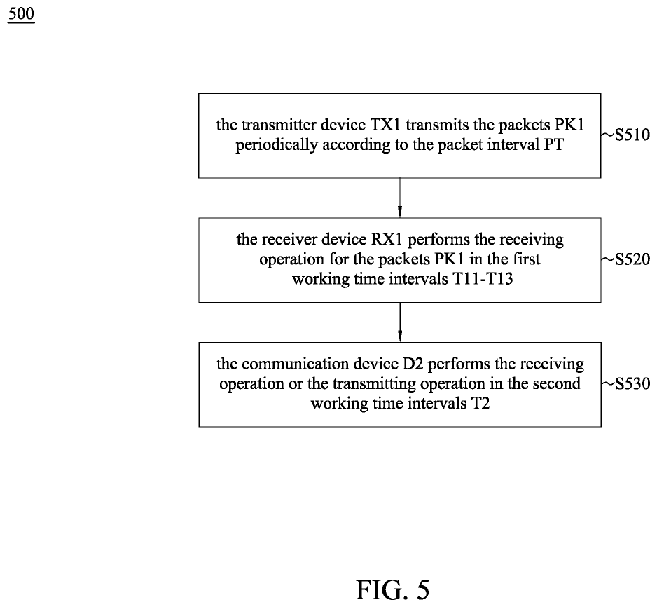

Reference is made to FIG. 5. FIG. 5 is a flow diagram illustrating a packet receiving method 500 according to some embodiments of the present disclosure. The packet receiving method 500 includes operations S510, S520, and S530. In some embodiments, the packet receiving method 500 is implemented by the packet receiving system 100 in FIG. 1.

In operation S510, the transmitter device TX1 transmits the packets PK1 periodically according to the packet gap PT.

In operation S520, the receiver device RX1 performs the receiving operation for the packets PK1 in the first working time intervals T11-T13. In some embodiments, the sum of the lengths of the first working time intervals T11-T13 is identical to the length of the packet gap PT. In some other embodiments, the sum of the lengths of the first working time intervals T11-T13 is greater than the length of the packet gap PT, in order to ensure that the receiver device RX1 can successfully receive the packets PK1.

In operation S530, the communication device D2 performs the receiving operation or the transmitting operation in the second working time intervals T2. In some embodiments, the length of the each of the second working time intervals T2 is equal to the length of the packet gap PT. The communication device D2 performs the receiving operation or the transmitting operation for the packets PK2 in the second working time intervals T2.

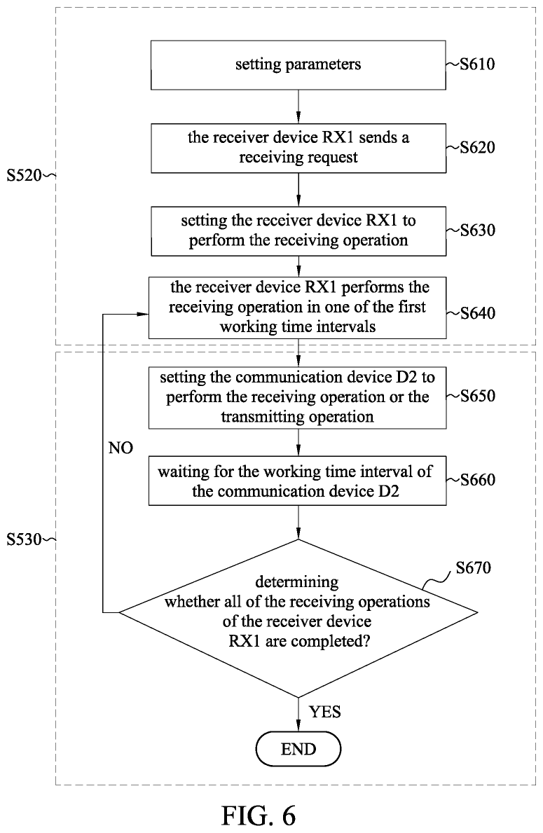

Reference is made to FIG. 6. FIG. 6 is a detailed flow diagram illustrating the operations S520 and S530 of the packet receiving method 500 in FIG. 5 according to some embodiments of the present disclosure. The operation S520 in FIG. 5 includes operations S610, S620, S630 and S640 in FIG. 6, and the operation S530 in FIG. 5 includes operations S650, S660, and S670 in FIG. 6.

Operation S610 is setting parameters. In some embodiments, the total length of the working time intervals T1′, the parameter N, the length of the protection time interval DT, or the length of the third working time interval T3 in the aforementioned formula (1) may be configured according to the practical applications. For example, the length of the total working time interval T1′ can be set individually. A number of (N) segments that the total working time interval T1′ is divided into can be set as well. In addition, the protection time interval DT can be set as a positive integer (to extend the length of the working interval) or a negative integer (to shorten the length of the working time interval).

In operation S620, the receiver device RX1 sends a receiving request. For example, the receiver device RX1 sends the receiving request for the periodic packets PK1.

Operation S630 is setting the receiver device RX1 to perform the receiving operation. For example, the receiver device RX1 is set to receive the packets PK1.

In operation S640, the receiver device RX1 performs the receiving operation in one of the first working time intervals. For example, if the length of the original working time interval T1 is divided into the length of the first working time interval T11, the length of the first working time interval T12, and the length of the first working time interval T13, the receiving operation of the first working time interval T11 can be performed at first. It is understood that the numbers of segments that the original working time interval T1 is divided into or the way that the original working time interval T1 is divided (e.g., divided into the same lengths) can be controlled according to the practical applications.

Operation S650 is setting the communication device D2 to perform the receiving operation or the transmitting operation. For example, the communication device D2 is set to receive or to transmit the packet PK2.

Operation S660 is waiting for the working time interval of the communication device D2. In the embodiments in FIG. 3, the length of one working time interval of the communication device D2 is the length of the packet gap PT minus the length of the protection time interval DT, but the present disclosure is not limited thereto. Alternative values are possible within the contemplated scopes of the present disclosure. For example, the length of the one of the working time intervals of the communication device D2 may be K times of the aforementioned length (i.e., the length of the packet gap PT minus the length of the protection time interval DT).

Operation S670 is determining whether all of the receiving operations of the receiver device RX1 (corresponding to the first working time intervals T11-T13) are completed. For example, if the receiving operation corresponding to the first working time interval T11 is completed but the receiving operation corresponding to the first working time interval T12 is not completed, the flow of the method can return to operation S640 to perform the receiving operation corresponding to the first working time interval T12. This rule is utilized until all of the receiving operations of the first working time intervals T11-T13 are completed.

As shown in the above embodiments, in the packet receiving system and the packet receiving method of the present disclosure, the receiving device and the communication device can work by turns so that the waiting time of the communication device can be reduced. This increases the successful receiving rate of the receiving device and prevents the communication device from a long waiting. Accordingly, the efficiency of the packet receiving system can be increased.

Various functional components or blocks have been described herein. As will be appreciated by persons skilled in the art, in some embodiments, the functional blocks will preferably be implemented through circuits (either dedicated circuits, or general purpose circuits, which operate under the control of one or more processors and coded instructions), which will typically comprise transistors or other circuit elements that are configured in such a way as to control the operation of the circuitry in accordance with the functions and operations described herein. As will be further appreciated, the specific structure or interconnections of the circuit elements will typically be determined by a compiler, such as a register transfer language (RTL) compiler. RTL compilers operate upon scripts that closely resemble assembly language code, to compile the script into a form that is used for the layout or fabrication of the ultimate circuitry. Indeed, RTL is well known for its role and use in the facilitation of the design process of electronic and digital systems.

Although the present disclosure has been described in considerable detail with reference to certain embodiments thereof, other embodiments are possible. It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A packet receiving system, comprising:
a transmitter device configured to transmit a plurality of packets periodically according to a packet gap;
a receiver device performing a receiving operation for the packets in a plurality of first working time intervals, wherein a sum of lengths of the first working time intervals corresponds to a length of the packet gap; and
a communication device performing a receiving operation or a transmitting operation in a plurality of second working time intervals, wherein a length of each of the second working time intervals corresponds to the length of the packet gap,
wherein each of the second working time intervals is arranged in between two of the first working time intervals.

2. The packet receiving system of claim 1, wherein the sum of the lengths of the first working time intervals is greater than the length of the packet gap.

3. The packet receiving system of claim 2, wherein the length of the packet gap is M seconds, the receiver device performs the receiving operation in N first working time intervals, and each of the N first working time intervals is greater than a ratio of M to N, wherein N is a positive integer greater than 1.

4. The packet receiving system of claim 1, wherein the sum of the lengths of the first working time intervals is equal to the length of the packet gap.

5. The packet receiving system of claim 4, wherein the length of the packet gap is M seconds, the receiver device performs the receiving operation in N first working time intervals, and each of the N first working time intervals is equal to a ratio of M to N, wherein N is a positive integer greater than 1.

6. The packet receiving system of claim 1, wherein the length of the each of the second working time intervals is equal to the length of the packet gap.

7. The packet receiving system of claim 1, wherein a sum of one of the first working time intervals and a protection time interval forms a third working time interval, the receiver device performs the receiving operation for the packets in the third working time interval, and each of the second working time intervals is arranged in between two of the third working time intervals.

8. The packet receiving system of claim 7, wherein the length of each of the second working time intervals is less than the length of the packet gap.

9. The packet receiving system of claim 1, wherein the length of one of the first working time intervals is less than the length of one of the second working time intervals.

10. The packet receiving system of claim 1, wherein the receiver device adopts Wi-Fi standard and the communication device adopts Bluetooth standard.

11. A packet receiving method, comprising:
transmitting a plurality of packets periodically according to a packet gap by a transmitter device;
performing a receiving operation for the packets in a plurality of first working time intervals by a receiver device, wherein a sum of lengths of the first working time intervals corresponds to a length of the packet gap; and
performing a receiving operation or a transmitting operation in a plurality of second working time intervals by a communication device, wherein a length of each of the second working time intervals corresponds to the length of the packet gap,
wherein each of the second working time intervals is arranged in between two of the first working time intervals.

12. The packet receiving method of claim 11, further comprising:
setting the sum of the lengths of the first working time intervals to be greater than the length of the packet gap.

13. The packet receiving method of claim 12, wherein the length of the packet gap is M seconds, the receiver device performs the receiving operation in N first working time intervals, and each of the N first working time intervals is greater than a ratio of M to N, wherein N is a positive integer greater than 1.

14. The packet receiving method of claim 11, further comprising:
setting the sum of the lengths of the first working time intervals to be equal to the length of the packet gap.

15. The packet receiving method of claim 14, wherein the length of the packet gap is M seconds, the receiver device performs the receiving operation in N first working time intervals, and each of the N first working time intervals is equal to a ratio of M to N, wherein N is a positive integer greater than 1.

16. The packet receiving method of claim 11, further-comprising:
setting the length of the each of the second working time intervals to be equal to the length of the packet gap.

17. The packet receiving method of claim 11, further comprising:
setting a third working time interval which is in length of a sum of one of the first working time intervals and a protection time interval, wherein the receiver device performs the receiving operation in the third working time interval; and
arranging each of the second working time intervals in between two of the third working time intervals.

18. The packet receiving method of claim 17, further comprising:
setting the length of each of the second working time intervals to be less than the length of the packet gap.

19. The packet receiving method of claim 11, wherein the length of one of the first working time intervals is less than the length of the one of the second working time intervals.

20. The packet receiving method of claim 11, wherein the receiver device adopts Wi-Fi standard, and the communication device adopts Bluetooth standard.
